(19) United States
(12) Patent Application Publication
(10) Pub. No.: US 2007/0151363 A1
(43) Pub. Date: Jul. 5, 2007

(54) Non-invasive sensing technique for measuring gas flow and temperature

(75) Inventor: Anilkumar Ramsesh, Bangalore (IN)

Correspondence Address: Kris T. Fredrick;Honeywell International Inc. - Patent Department, 101 Columbia Road, Morristown, NJ, 07962, US

(73) Assignee: Honeywell International Inc.

(21) Appl. No.: 11/343,146

(22) Filed: Jan. 30, 2006

Related U.S. Application Data
(60) Provisional application No. 60/755,352, filed on Dec. 30, 2005.

(51) Int. Cl. G01F 1/66

(52) U.S. Cl. 73/861.27

(57) ABSTRACT

A non-invasive method for measuring the flow rate and temperature of a gas flowing through a gas passageway. An inventive ultrasound sensor assembly includes a housing having opposed first and second ultrasound transducers. The housing is attachable onto an outside surface of a gas passageway, such as a pipe, at an angle θ relative to a gas low direction within the gas passageway. Ultrasonic signals are sent from the first ultrasound transducer to the second ultrasound transducer, and vice versa, through the gas flow. Gas flow velocity and gas temperature are determined with the measured transit times of these ultrasonic signals through the gas flow. This non-invasive method eliminates sensor degradation, and eliminates the need for separate flow and temperature sensors. It also reduces power and time requirements, thus reducing cost.

### CROSS REFERENCE TO RELATED APPLICATION

This application claims the benefit of provisional application Ser. No. 60/755,352 filed Dec. 30, 2005, which is incorporated herein by reference.

### BACKGROUND OF THE INVENTION

1. Field of the Invention

The present invention relates to the measurement of gas flow and temperature. More particularly, it relates to a non-invasive method for measuring the flow rate and temperature of a gas flow through a gas passageway such as an exhaust pipe.

2. Description of the Related Art

Various applications require measurement of the mass flow rate of a gas or mixture of gases at ambient or elevated temperatures. In particular, automotive applications measure exhaust gas flow rates for engine control. Measuring exhaust gas in an engine cylinder is a highly dynamic and complicated process. The mass flow rate, temperature, and pressure of the gas fluctuate, particularly during engine operation.

Automobile manufacturers have developed a variety of gas flow sensors for placement within the exhaust systems of their automobiles. However, due to problems associated with constant exposure to the harsh exhaust system environment, many of these sensors have been unsuccessful. For example, many automobile manufacturers use conventional hot film anemometer techniques for measuring the mass flow rate of automobile exhaust gas. These techniques use gas flow sensors, or anemometers, which are also placed within an exhaust system, into a gas flow path to measure the mass flow rate of an exhaust gas. A separate temperature sensor is used to measure gas temperature. However, a variety of problems exist with these conventional techniques, such as sensor degradation, pressure drop at high velocity, and increases in back pressure causing pulsation.

The automotive applications require both flow rate and temperature of the gas, which varies greatly for estimating percentage exhaust gas re-circulation. Furthermore, hot film anemometers are known to degrade over time in harsh environments due to thermal cycling and soiling by dust transported with exhaust gases. Such degradation causes the heat transfer coefficient of the gas flow sensors to vary greatly, thereby introducing error into gas flow rate measurements. Thus, in an attempt to minimize errors in measurement, it would be desirable to develop a non-invasive system for measuring gas flow rate and temperature.

Ultrasound gas flow measurement techniques are known, such as in Ultrasound Doppler techniques. However, these systems are disadvantageous since they typically only work where a medium whose velocity is measured has suspended particles. Additionally, these systems require multiple ultrasound transmitters/receivers, and are often invasive in that they require attachment to ports built into the wall of an exhaust pipe or the like. Additionally, these systems do not measure the temperature of a medium. Rather, they require a separate temperature sensor.

The present invention provides a novel non-invasive ultrasound sensor assembly and method for determining both gas flow rate and gas temperature, preferably simultaneously, using single sensor and without invading the gas flow path. The invention uses ultrasound, acoustic anemometry, and acoustic pyrometry techniques to overcome the problems of conventional sensors.

An ultrasound sensor assembly of the invention is attached onto an outer surface of a gas passageway, at a predetermined angle relative to a gas flow direction within the gas passageway. Gas flow rate is proportional to the transit time of a sound wave in the gas medium. Thus, when ultrasonic signals are sent from a first ultrasound transducer of the ultrasound sensor assembly to a second ultrasound transducer of the assembly, and vice versa, through a gas flow path, the gas flow rate is determined with the measured transit times of these ultrasonic signals. Furthermore, the velocity of sound in a medium is a function of the medium's temperature. Thus, from the measured transit times of the ultrasonic signals, the gas temperature is determined. The inventive method is advantageous since it is non-invasive, and therefore the ultrasound assembly does not experience degradation caused by a harsh environment within the gas passageway. In addition, only a single ultrasound sensor assembly of this invention is necessary to simultaneously determine both mass flow rate and temperature of a gas. Thus, power requirements and time requirements are reduced, lowering costs.

### SUMMARY OF THE INVENTION

The invention provides a non-invasive method for determining the flow velocity and temperature of a gas within a gas passageway, comprising the steps of:
I) providing a gas passageway for the passage of gas therethrough;
II) attaching an ultrasound sensor assembly onto an outer surface of the gas passageway, at an angle θ relative to a gas flow direction within the gas passageway, which ultrasound sensor assembly comprises:
   a) a housing having a first ultrasound transducer and an opposed second
   ultrasound transducer; and
   b) a data processor unit attached to both the first ultrasound transducer and the second ultrasound transducer;
   which first ultrasound transducer is capable of transmitting ultrasonic signals to the second ultrasound transducer and receiving ultrasonic signals from the second ultrasound transducer, and which second ultrasound transducer is capable of transmitting ultrasonic signals to the first ultrasound transducer and receiving ultrasonic signals from the first ultrasound transducer; which data processor unit is capable of determining signal travel times of ultrasonic signals transmitted from the first ultrasound transducer and received by the second ultrasound transducer, and determining signal travel times of ultrasonic signals transmitted from the second ultrasound transducer and received by the first ultrasound transducer; which data processor unit is capable of determining the flow velocity of a gas within the gas passageway with the signal travel times; and which data processor unit is capable of determining the gas temperature of a gas within the gas passageway with the signal travel times;
III) transmitting a first ultrasonic signal from the first ultrasound transducer, through the gas passageway, to the second ultrasound transducer which second ultrasound transducer receives said first signal;
IV) transmitting a second ultrasonic signal from the second ultrasound transducer, through the gas passageway, to the first ultrasound transducer which first ultrasound transducer receives said second signal;
V) determining a first signal travel time of the first ultrasonic signal from the first ultrasound transducer to the second ultrasound transducer and a second signal travel time of the second ultrasonic signal from the second ultrasound transducer to the first ultrasound transducer, via the data processor unit;
VI) thereafter determining the flow velocity of a gas within the gas passageway, via the data processor unit with the first signal travel time and the second signal travel time; and
VII) determining the gas temperature of a gas within the gas passageway, via the data processor unit with the first signal travel time and the second signal travel time.

The invention also provides a vehicle system which comprises:
I) a gas flow generator for generating a gas flow;
II) a gas passageway, connected to the gas flow generator, for flowing gas away from the gas flow generator; and
III) an ultrasound sensor assembly attached onto an outer surface of the gas passageway, at an angle θ relative to the gas flow direction within the gas passageway, which ultrasound sensor assembly comprises:
   a) a housing having a first ultrasound transducer and an opposed second ultrasound transducer; and
   b) a data processor unit attached to both the first ultrasound transducer and second ultrasound transducer;
   which first ultrasound transducer is capable of transmitting ultrasonic signals to the second ultrasound transducer and receiving ultrasonic signals from the second ultrasound transducer, and which second ultrasound transducer is capable of transmitting ultrasonic signals to the first ultrasound transducer and receiving ultrasonic signals from the first ultrasound transducer; which data processor unit is capable of determining signal travel times of ultrasonic signals transmitted from the first ultrasound transducer and received by the second ultrasound transducer, and determining signal travel times of ultrasonic signals transmitted from the second ultrasound transducer and received by the first ultrasound transducer; which data processor unit is capable of determining the flow velocity of a gas within the gas passageway with the signal travel times; and which data processor unit is capable of determining the gas temperature of a gas within the gas passageway with the signal travel times.

The invention further provides an ultrasound sensor assembly for determining the flow velocity and temperature of a gas, comprising:
a) a housing having a first ultrasound transducer and an opposed second ultrasound transducer; which housing is attachable onto an outer surface of a gas passageway, at an angle θ relative to a gas flow direction within the gas passageway; and
b) a data processor unit attached to both the first ultrasound transducer and second ultrasound transducer;
which first ultrasound transducer is capable of transmitting ultrasonic signals to the second ultrasound transducer and receiving ultrasonic signals from the second ultrasound transducer, and which second ultrasound transducer is capable of transmitting ultrasonic signals to the first ultrasound transducer and receiving ultrasonic signals from the first ultrasound transducer; which data processor unit is capable of determining signal travel times of ultrasonic signals transmitted from the first ultrasound transducer and received by the second ultrasound transducer, and determining signal travel times of ultrasonic signals transmitted from the second ultrasound transducer and received by the first ultrasound transducer; which data processor unit is capable of determining the flow velocity of a gas within the gas passageway with the signal travel times; and which data processor unit is capable of determining the gas temperature of a gas within the gas passageway with the signal travel times.

### BRIEF DESCRIPTION OF THE DRAWINGS

FIG. 1 shows a side cut-away view of an ultrasound sensor assembly of the invention, attached onto an outer surface of a gas passageway at an angle θ relative to a gas flow direction within the gas passageway.

FIG. 2 shows a cross sectional view of an ultrasound sensor assembly of the invention attached to an outer surface of a gas passageway.

FIG. 3 shows a side cut-away view of an ultrasound sensor assembly as in FIG. 1, showing a data processor unit attached to each of the first and second ultrasound transducers.

### DETAILED DESCRIPTION OF THE INVENTION

The invention provides an ultrasound sensor assembly. In use, the ultrasound sensor assembly is capable of non-invasively determining the flow velocity and temperature of a gas within a gas passageway or the like.

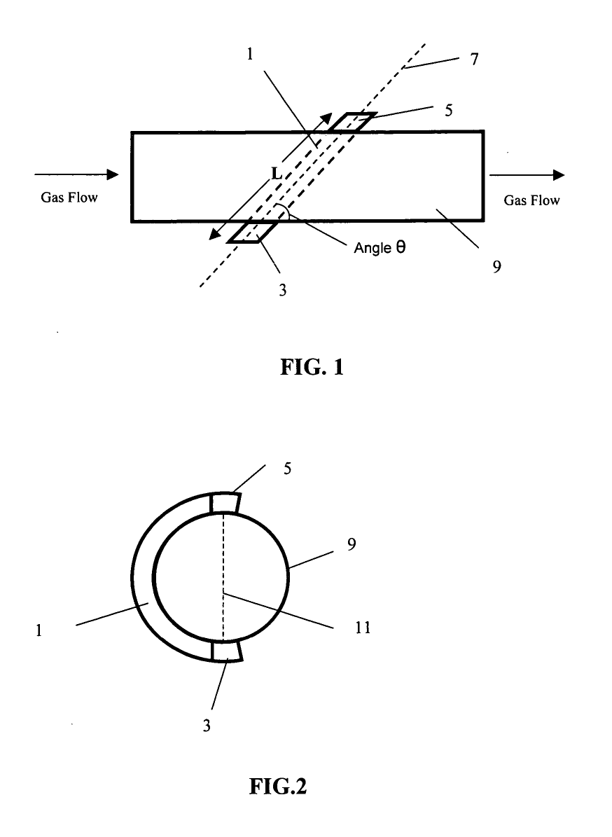

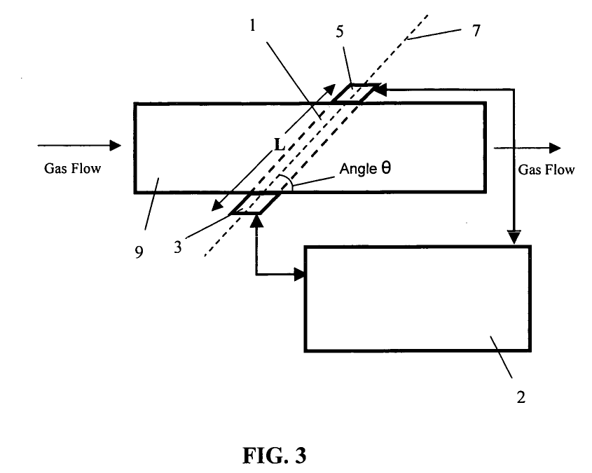

As shown in FIGS. 1-3, the inventive ultrasound sensor assembly comprises a housing 1 having a first ultrasound transducer 3, and an opposed second ultrasound transducer 5. The housing 1 is to be attached onto an outer surface of a gas passageway 9. A gas passageway 9 may comprise any suitable construction such as a tube, pipe, manifold or the like which is capable of transporting a gas. In one embodiment the gas passageway 9 comprises a stainless steel pipe. The housing 1 may comprise any suitable shape, such as a ring or C-clamp or the like, for secure attachment onto such a gas passageway 9. FIG.2 shows one embodiment wherein the housing 1 is present in the shape of a C-clamp which is attached onto an outer surface of a gas passageway 9. The housing 1 preferably does not come into physical contact with an inner surface of the gas passageway 9 and is not integral with an inner surface of the gas passageway 9. The housing further preferably does not come into physical contact with a gas flow within the gas passageway 9. The housing 1 may comprise any suitable material such as metal, plastic, or the like, which is capable of withstanding the environmental conditions exerted on an outer surface of the gas passageway 9. Specific materials for the housing 1 are to be determined by those skilled in the art.

As illustrated in FIG. 2, the housing 1 is preferably attachable onto an outer surface of a gas passageway 9 such that first and second ultrasound transducers 3, 5 are positioned approximately opposite each other along a longitudinal diameter 11 of the gas passageway 9. As shown in FIG. 1, the housing 1 is attachable onto an outer surface of a gas passageway 9, at an angle θ relative to a gas flow direction within the gas passageway 9. The housing 1 is preferably removably attachable from the outer surface of the gas passageway 9, at an angle θ relative to the gas flow direction within the gas passageway 9. Gas flow measurement is a function of the direction or angle of the housing 1 in relation to the gas passageway 9. The angle θ also represents the angle between the path 7 of an ultrasonic signal (described below) passing through the gas passageway 9, and the direction of gas flow through the gas passageway 9. In one embodiment, the angle θ is greater than 0° but less than 90° relative to the gas flow direction within the gas passageway 9. In another embodiment, the angle θ is greater than 90° but less than 180° relative to the gas flow direction within the gas passageway 9.

The first and second ultrasound transducers 3, 5 of the housing 1 are capable of transmitting and receiving ultrasonic signals therebetween. Preferably, the first ultrasound transducer 3 is capable of transmitting ultrasonic signals to the second ultrasound transducer 5 and receiving ultrasonic signals from the second ultrasound transducer 5; and the second ultrasound transducer 5 is capable of transmitting ultrasonic signals to the first ultrasound transducer 3 and receiving ultrasonic signals from the first ultrasound transducer 3.

These signals may be in the form of ultrasonic pulses or the like. Suitable transducers nonexclusively include piezoelectric transducers, electromagnetic acoustic transducers (EMAT), magnetorestrictive transducers, interdigital ultrasonic transducers, radio frequency transducers, and active transducers such as millimeter wave transducers. Piezoelectric transducers are preferred, and are commercially available. The first and second ultrasonic transducers 3, 5 may be integral with the housing 1, or may be attached to the housing 1 by any suitable means such as gluing, welding, soldering, and the like.

The voltage, frequency, and other parameters of the ultrasonic signals sent by the first and second ultrasound transducers 3, 5 may vary depending on the size of the gas passageway 9, the angle θ and the type of transducers used, as well as other factors, and may be determined by those skilled in the art. As an example, piezoelectric transducers may generate ultrasonic signals having a frequency ranging from about 20 kHz to about 5 MHz, more preferably from about 20 kHz to about 1 MHz, and most preferably from about 40 kHz to about 100 kHz.

The ultrasound sensor assembly further comprises a data processor unit 2, attached to both the first ultrasound transducer 3 and the second ultrasound transducers 5, as shown in FIG.3. The data processor unit 2 may be attached to the first ultrasound transducer 3 and the second ultrasound transducer 5 either internally or externally, via wires or cables or the like.

The data processor unit 2 serves as a control module of the system, and may comprise any suitable control electronics as necessary for controlling the various components of the ultrasound sensor assembly. Examples of suitable control electronics of the data processor unit nonexclusively include data memories, signal receivers, switching units, circuits such as transmitter and receiver circuits, and firmware such as in microcontrollers, microprocessors, minicomputers, and the like. The data processor unit 2 is preferably capable of performing signal processing and data calculation functions and the like, as described below. The data processor unit 2 and its control electronics may comprise any suitable software or codes necessary for such data calculation functions, and for the control of the ultrasound sensor assembly. The data processor 2 may further be connected to other external devices via output terminals and the like. In addition, the data processor may include output terminals relating to gas temperature output, gas flow rate output, and the like.

Importantly, the data processor unit 2 is capable of determining signal travel times of ultrasonic signals transmitted from the first ultrasound transducer 3 and received by the second ultrasound transducer 5, and determining signal travel times of ultrasonic signals transmitted from the second ultrasound transducer 5 and received by the first ultrasound transducer 3. The data processor unit 2 is further capable of determining the flow velocity of a gas within the gas passageway 9 with these signal travel times. The data processor unit 2 is still further capable of determining the gas temperature of a gas within the gas passageway 9 with these signal travel times.

In use, a housing 1 of an ultrasound sensor assembly is attached onto an outer surface of a gas passageway 9 at a prescribed angle θ relative to a gas flow direction within the gas passageway, as described above. A first ultrasonic signal is transmitted from the first ultrasound transducer 3, through the gas passageway 9, along a path 7 across a gas flow within the gas passageway 9, to the second ultrasound transducer 5, which second ultrasound transducer 5 receives said first signal. A second ultrasonic signal is transmitted from the second ultrasound transducer 5, through the gas passageway 9, along a path 7 across a gas flow within the gas passageway 9, to the first ultrasound transducer 3, which first ultrasound transducer 3 receives said second signal. Preferably, the first ultrasonic signal travels approximately with the direction of gas flow, and the second ultrasonic signal travels approximately against the direction of gas flow.

The data processor unit 2 then determines a first signal travel time of the first ultrasonic signal from the first ultrasound transducer 3 to the second ultrasound transducer 5, and a second signal travel time of the second ultrasonic signal from the second ultrasound transducer 5 to the first ultrasound transducer 3. A signal travel time is the total time it takes a signal to travel from one transducer, across a medium within the gas passageway, and to the other transducer. The data processor unit 2 thereafter determines the flow velocity of a gas within the gas passageway 9, with the first signal travel time and the second signal travel time. Gas temperature of a gas within the gas passageway 9 is also determined by the data processor unit 2, with the first signal travel time and the second signal travel time. In a preferred embodiment, the flow velocity and the gas temperature are determined simultaneously via the data processor unit 2.

Flow velocity may be determined using Formula 1:

$$v = \frac{L}{2} Cos θ ( \frac{( {τ}_{2} - {τ}_{1} )}{{τ}_{1} {τ}_{2}} ) \qquad ( Formula 1 )$$

where:
   L is the distance between the first ultrasound transducer and the second ultrasound transducer;
   θ is the angle between the path of ultrasound signal travel and the direction of gas flow;
   τ₁ is the travel time of the first ultrasonic signal, in the direction of gas flow; and
   τ₂ is the travel time of the second ultrasonic signal, in the direction against gas flow.

From Formula 1 it can be observed that the measurement of gas velocity (ν), is independent of the velocity of sound. Furthermore, the velocity of sound (c) is a function of the temperature of a medium through which the sound travels. This is shown by Formula 2:

$$c = {[ \frac{γ RT}{M} ]}^{\frac{1}{2}} \qquad ( Formula 2 )$$

where:
   T is gas temperature in degree Kelvin (K);
   M is the molecular weight of the gas in kg/mole;
   R is the universal gas constant of 8.314 j/mole-K; and
   γ represents the ratios of specific heats of ambient air to exhaust gas.

The velocity of sound (c) from Formula 2 can be inserted into Formula 1 and solved for temperature (T) as shown in Formula 3 to determine gas temperature:

$$T = \frac{{M [ \frac{L}{{τ}_{1}} + v Cos θ ]}^{2}}{γ R} \qquad ( Formula 3 )$$

The technique of determining temperature is referred to as acoustic pyrometry. Thus, the present invention utilizes the principles of acoustic anemometry and acoustic pyrometry which may be employed to simultaneously measure the flow and temperature of the gas.

A further embodiment of this invention includes a vehicle system, such as a vehicle gas flow system or a vehicle exhaust system. The vehicle system comprises a gas flow generator for generating a gas flow. Such gas flow generator may comprise an exhaust generator or steam generator or the like. The gas flow generator is connected to a gas passageway, which gas passageway serves to flow gas away from the gas flow generator. Suitable gas passageways are described in detail above. Further, an ultrasound sensor assembly of the invention is attached onto an outer surface of the gas passageway at an angle θ relative to the gas flow direction within the gas passageway, as described above. Such vehicle systems would be useful in a variety of automobile applications and the like.

While the present invention has been particularly shown and described with reference to preferred embodiments, it will be readily appreciated by those of ordinary skill in the art that various changes and modifications may be made without departing from the spirit and scope of the invention. It is intended that the claims be interpreted to cover the disclosed embodiment, those alternatives which have been discussed above and all equivalents thereto.

What is claimed is:

1. A non-invasive method for determining the flow velocity and temperature of a gas within a gas passageway, comprising the steps of:
I) providing a gas passageway for the passage of gas therethrough;
II) attaching an ultrasound sensor assembly onto an outer surface of the gas passageway, at an angle θ relative to a gas flow direction within the gas passageway, which ultrasound sensor assembly comprises:
a) a housing having a first ultrasound transducer and an opposed second ultrasound transducer; and
b) a data processor unit attached to both the first ultrasound transducer and the second ultrasound transducer;
which first ultrasound transducer is capable of transmitting ultrasonic signals to the second ultrasound transducer and receiving ultrasonic signals from the second ultrasound transducer, and which second ultrasound transducer is capable of transmitting ultrasonic signals to the first ultrasound transducer and receiving ultrasonic signals from the first ultrasound transducer; which data processor unit is capable of determining signal travel times of ultrasonic signals transmitted from the first ultrasound transducer and received by the second ultrasound transducer, and determining signal travel times of ultrasonic signals transmitted from the second ultrasound transducer and received by the first ultrasound transducer; which data processor unit is capable of determining the flow velocity of a gas within the gas passageway with the signal travel times; and which data processor unit is capable of determining the gas temperature of a gas within the gas passageway with the signal travel times;
III) transmitting a first ultrasonic signal from the first ultrasound transducer, through the gas passageway, to the second ultrasound transducer which second, ultrasound transducer receives said first signal;
IV) transmitting a second ultrasonic signal from the second ultrasound transducer, through the gas passageway, to the first ultrasound transducer which first ultrasound transducer receives said second signal;
V) determining a first signal travel time of the first ultrasonic signal from the first ultrasound transducer to the second ultrasound transducer and a second signal travel time of the second ultrasonic signal from the second ultrasound transducer to the first ultrasound transducer, via the data processor unit;
VI) thereafter determining the flow velocity of a gas within the gas passageway, via the data processor unit with the first signal travel time and the second signal travel time; and
VII) determining the gas temperature of a gas within the gas passageway, via the data processor unit with the first signal travel time and the second signal travel time.

2. The method of claim 1 wherein the flow velocity of step (VI) and the gas temperature of step (VII) are determined simultaneously.

3. The method of claim 1 wherein the angle θ is greater than 0° but less than 90° relative to the gas flow direction within the gas passageway.

4. The method of claim 1 wherein the angle θ is greater than 90° but less than 180° relative to the gas flow direction within the gas passageway.

5. The method of claim 1 wherein the data processor unit is electrically attached to the first ultrasound transducer and the second ultrasound transducer via wires or cables.

6. The method of claim 1 wherein the attaching of the ultrasound sensor assembly onto an outer surface of the gas passageway is conducted by the housing which comprises a clamp.

7. The method of claim 1 wherein the gas passageway comprises a tube, a pipe, or a manifold which is capable of transporting a gas therethrough.

8. A vehicle system which comprises:
I) a gas flow generator for generating a gas flow;
II) a gas passageway, connected to the gas flow generator, for flowing gas away from the gas flow generator; and
III) an ultrasound sensor assembly attached onto an outer surface of the gas passageway, at an angle θ relative to the gas flow direction within the gas passageway, which ultrasound sensor assembly comprises:
a) a housing having a first ultrasound transducer and an opposed second
ultrasound transducer; and
b) a data processor unit attached to both the first ultrasound transducer and second ultrasound transducer;
which first ultrasound transducer is capable of transmitting ultrasonic signals to the second ultrasound transducer and receiving ultrasonic signals from the second ultrasound transducer, and which second ultrasound transducer is capable of transmitting ultrasonic signals to the first ultrasound transducer and receiving ultrasonic signals from the first ultrasound transducer; which data processor unit is capable of determining signal travel times of ultrasonic signals transmitted from the first ultrasound transducer and received by the second ultrasound transducer, and determining signal travel times of ultrasonic signals transmitted from the second ultrasound transducer and received by the first ultrasound transducer; which data processor unit is capable of determining the flow velocity of a gas within the gas passageway with the signal travel times; and which data processor unit is capable of determining the gas temperature of a gas within the gas passageway with the signal travel times.

9. The vehicle exhaust system of claim 8 wherein the angle θ is greater than 0° degrees but less than 90° relative to the gas flow direction within the gas passageway.

10. The vehicle exhaust system of claim 8 wherein the angle θ is greater than 90° but less than 180° relative to the gas flow direction within the gas passageway.

11. The vehicle exhaust system of claim 8 wherein the processor is electrically attached to the first ultrasound transducer and the second ultrasound transducer via wires or cables.

12. The vehicle exhaust system of claim 8 wherein the housing comprises a clamp.

13. The vehicle exhaust system of claim 8 wherein the gas passageway comprises a tube, a pipe, or a manifold which is capable of transporting a gas therethrough.

14. An ultrasound sensor assembly for determining the flow velocity and temperature of a gas, comprising:
a) a housing having a first ultrasound transducer and an opposed second ultrasound transducer; which housing is attachable onto an outer surface of a gas passageway, at an angle θ relative to a gas flow direction within the gas passageway; and
b) a data processor unit attached to both the first ultrasound transducer and second ultrasound transducer;
which first ultrasound transducer is capable of transmitting ultrasonic signals to the second ultrasound transducer and receiving ultrasonic signals from the second ultrasound transducer, and which second ultrasound transducer is capable of transmitting ultrasonic signals to the first ultrasound transducer and receiving ultrasonic signals from the first ultrasound transducer; which data processor unit is capable of determining signal travel times of ultrasonic signals transmitted from the first ultrasound transducer and received by the second ultrasound transducer, and determining signal travel times of ultrasonic signals transmitted from the second ultrasound transducer and received by the first ultrasound transducer; which data processor unit is capable of determining the flow velocity of a gas within the gas passageway with the signal travel times; and which data processor unit is capable of determining the gas temperature of a gas within the gas passageway with the signal travel times.

15. The ultrasound sensor assembly of claim 14 which is removably attachable onto an outer surface of a gas passageway, at an angle θ relative to the gas flow direction within the gas passageway.

16. The ultrasound sensor assembly of claim 14 wherein the angle θ is greater than 0° degrees but less than 90° relative to the gas flow direction within the gas passageway.

17. The ultrasound sensor assembly of claim 14 wherein the angle θ is greater than 90° but less than 180° relative to the relative to a gas flow direction within the gas passageway.

18. The ultrasound sensor assembly of claim 14 wherein the data processor unit is electrically attached to the first ultrasound transducer and the second ultrasound transducer via wires or cables.

19. The ultrasound sensor assembly of claim 14 wherein the housing comprises a clamp.

20. The ultrasound sensor assembly of claim 14 wherein the gas passageway comprises a tube, a pipe, or a manifold which is capable of transporting a gas therethrough.
